(19) United States
(12) Patent Application Publication
(10) Pub. No.: US 2022/0298357 A1
(43) Pub. Date: Sep. 22, 2022

(54) METHOD FOR COATING A COMPOSITE SUBSTRATE

(71) Applicant: SAFRAN, PARIS (FR)

(72) Inventors: Sophie SENANI, MOISSY-CRAMAYEL (FR); Martine MONIN, MOISSY-CRAMAYEL (FR); Cornaline HUMBERT, MOISSY-CRAMAYEL (FR)

(21) Appl. No.: 17/638,632

(22) PCT Filed: Aug. 27, 2020
(86) PCT No.: PCT/FR2020/051508

§ 371 Date: Feb. 25, 2022

(30) Foreign Application Priority Data
Aug. 27, 2019 (FR) FR1909422

(51) Int. Cl. C09D 1/00; C23C 18/12; C09D 5/02; C09D 5/00; C09D 7/61; C09D 7/65

(52) U.S. Cl. CPC C09D 1/00; C23C 18/1254; C23C 18/1295; C09D 5/028; C09D 5/002; C09D 7/61; C09D 7/65

(57) ABSTRACT

A method for coating a composite substrate characterized includes a—preparing a sol-gel composition by mixing in an aqueous medium: 1—of at least one metal alkoxide of formula (I) M(OR¹), 2—in the presence of at least one organo alkoxysilane of formula (II) R³mSi(OR²)₄₋ₘ, 3—and in the presence of optional oxide or metal particles, 4—by mixing the composition in order to allow condensation of the organic-inorganic hybrid networks, b—depositing at least one underlayer of the sol-gel composition obtained in step a) on the composite substrate; c—depositing at least one subsequent coating layer on the coated composite substrate obtained in step b).

The invention concerns the field of wet surface treatment of composite material substrates, in particular organic matrix composite (OMC) materials.

Currently, metal parts on an OMC substrate are mainly created by fabricating glued-on forged parts. However, this method has constraints and issues with gluing and matching up parts.

In order to deal with these issues, the literature presents testing of deposits, primarily metal, by different thermal spraying methods such as cold spray or suspension plasma spraying (SPS). Thermal spraying is in fact a usual method on metal aeronautical parts which makes it possible to produce coatings, most often also metal. The principle of thermal spraying methods such as cold spray or suspension plasma spraying (SPS) or air plasma spraying (APS) or flame spraying (high-velocity oxy-fuel (HVOF)) spraying consists of high-speed spraying of particles heated to a high temperature (i.e., depending on the method, from 180° C. to the melting temperature of the particles).

However, in order not to alter the mechanical properties of OMCs, they have temperature and mechanical exposure limit constraints during the process. Thus, the recent attempts at deposition by thermal spraying on an organic matrix composite substrate published in the literature all almost always lead to erosion of the substrate that could go as far as damaging superficial strands or a deposit of very low adhesion (i.e., <1 MPa).

Indeed, the use of these methods on OMC substrates mainly leads to damage due to heat and erosion as well as the kinetics and the calorie input of the sprayed particles. This damage of the first plies of the OMC is reflected by exposure of the reinforcing fibres and a nonadhesive coating.

The inventors surprisingly realized that it was possible to protect the organic matrix composite by using a sol-gel underlayer deposited before deposition by thermal spraying, in particular of organic/inorganic hybrid sol-gel. This underlayer can be considered as a surface preparation or a bonding layer, before depositing a subsequent layer by thermal spraying.

This underlayer therefore has three functions:
1 protection of the OMC substrate from erosion by the sprayed particles;
2 increase of the adhesion of the coating:
   with the OMC substrate (interface 1) mainly due to chemical compatibility
   and with the deposition by thermal spraying (interface 2) mainly via mechanical anchoring resulting from the roughness of the surface and potentially from chemical interactions related to the formulation;
3 improvement of the adhesion with use between the OMC substrate and the upper layer obtained by thermal spraying due to an appropriate coefficient of thermal expansion.

The inventors also realized that such an underlayer could also protect other types of composites such as ceramic matrix composites (CMC) or metal matrix composites (MMC).

They finally realized that such an underlayer could improve the adhesion on the composites during other types of coating deposition such as dip-coating.

The present invention therefore relates to a method for coating a composite substrate, characterized in that it comprises the following steps:

a—preparing a sol-gel composition by mixing in an aqueous medium, in particular in water or a water/alcohol mixture, more particularly acidified water, for example by acetic acid or nitric acid:

1—of at least one metal alkoxide of formula (I) M(OR¹)ₓ wherein

R¹ is a C₁-C₄ alkyl group, in particular propyl or butyl,

M is a metal chosen from the group consisting of transition metals, lanthanides, a phosphorus, magnesium, tin, zinc, aluminum and antimony, advantageously from the group consisting of Cu, Mn, Sn, Fe, Mg, Zn, Al, P, Sb, Zr, Ti, Hf, Ce, Nb, V and Ta, more advantageously from the group consisting of Zr, Ti, Al and Sb, even more advantageously from the group consisting of Zr, Ti and Al, more particularly the metal is identical to the metal of the subsequent coating layer, in particular deposited by spraying (see step c) below), and

x is an integer representing the metal valence,

advantageously, with stirring for the necessary time to hydrolyze and condense the organic-inorganic hybrid network, in particular for several minutes to several hours, more particularly between 15 minutes and 5 hours;

2—in the presence of at least one organo alkoxysilane of formula (II)

R³ₘSi(OR²)₄₋ₘ, wherein

R² represents a C₁-C₄ alkyl group, in particular methyl, ethyl or isopropyl,

m represents an integer chosen between 1, 2 and 3, in particular 1,

and each R³ represents, independently of one another, a non-hydrolysable group chosen from polydimethylsiloxane, a C₁-C₁₈ alkyl group, C₂-C₄ alkenyl group, C₂-C₄ alkynyl group, C₆-C₁₀ aryl group, methacryl, methacryl (C₁-C₁₀ alkyl) (such as methacrylpropyl) or methacryloxy(C₁-C₁₀ alkyl) (such as methacrybxypropyl), epoxylakyl or epoxyalkoxyalkyl in which the alkyl group is a linear, branched or cyclic C₁-C₁₀ alkyl group and the alkoxy group is linear or branched C₁-C₁₀ alkoxy group (such as glycidyl and glycidyloxy(C₁-C₁₀ alkyl) in particular glycidyloxypropyl), C₂-C₁₀ haloalkyl (such as 3-chloropropyl), C₂-C₁₀ perhaloalkyl (such as perfluoropropyl), C₂-C₁₀ mercaptoalkyl (such as mercaptopropyl), C₂-C₁₀ aminoalkyl (such as aminopropyl), (C₂-C₁₀ aminoalkyl)amino(C₂-C₁₀ alkyl) (such as 3-[(2-aminoethyl)amino]propyl), di(C₂-C₁₀ alkylene)triamino(C₂-C₁₀ alkyl) (such as 3-[diethylenetriamino]propyl), imidazolyl-(C₂-C₁₀ alkyl) and C₂-C₁₀ imidoalkyl, in particular each R³ represents, independently of one another, a non-hydrolysable group chosen from an epoxylakyl or epoxyalkoxyalkyl group in which the alkyl group is linear, branched or cyclic C₁-C₁₀ alkyl group and the alkoxy group is linear or branched C₁-C₁₀ alkoxy group (such as glycidyl and glycidyloxy(C₁-C₁₀ alkyl) in particular glycidyloxypropyl) and C₂-C₁₀ aminoalkyl (such as aminopropyl), the organo alkoxysilane may advantageously have been mixed beforehand with an aqueous medium, in particular with water or a water/alcohol mixture, more particularly acidified water, with stirring for the time necessary to hydrolyse and condense the organic-inorganic hybrid network,

3—and in the presence of optional oxide or metal particles such as, for example, SiO₂, ZrO₂, TiO₂, Ag, Al, Ti and mixtures thereof, in particular from ZrO₂ and TiO₂;

4—by mixing the composition, in particular for several minutes to several hours, more particularly with stirring, in order to permit the condensation of the organic-inorganic hybrid networks;

b—depositing at least one underlayer of the sol-gel composition obtained in step a) on a composite substrate;

c—and depositing at least one subsequent coating layer, in particular by spraying, on the composite substrate coated with the underlayer obtained in step b).

The method according to the invention can also comprise a step d) of recovering the coated composite substrate obtained in step c).

In a particular embodiment of the invention, the metal alkoxide of formula (I) according to the invention was previously reacted with the aqueous medium, in particular for the time necessary for the condensation of the organic-inorganic hybrid networks, before being brought into the presence of the organo alkoxysilane of formula (II) according to the invention.

Within the meaning of the present invention, “C₁-C₄ alkyl group” means any linear or branched alkyl group comprising from 1 to 4 carbon atoms.

It can thus be a methyl, ethyl, n-propyl, isopropyl, n-butyl, sec-butyl or tert-butyl group, preferably methyl, ethyl or isopropyl, in particular ethyl or methyl.

Within the meaning of the present invention, “C₁-C₁₈ alkyl group” means any linear or branched alkyl group comprising from 1 to 18 carbon atoms.

It can thus be a methyl, ethyl, n-propyl, isopropyl, n-butyl, sec-butyl, tert-butyl, n-pentyl, n-hexyl heptyl, octyl, nonyl, decyl, undecyl, dodecyl, tridecyl, tetradecyl, pentadecyl, hexadecyl, heptadecyl or octadecyl group, preferably methyl, ethyl or isopropyl, in particular ethyl or methyl.

Within the meaning of the present invention, “C₁-C₁₀ alkyl group” means any linear or branched alkyl group comprising from 1 to 10 carbon atoms.

It can thus be a methyl, ethyl, n-propyl, isopropyl, n-butyl, sec-butyl, tert-butyl, n-pentyl, n-hexyl, heptyl, octyl, nonyl, or decyl group, preferably methyl, ethyl or propyl, in particular ethyl or propyl.

Within the meaning of the present invention, “C₂-C₄ alkene group” means any alkene group with 2 to 4 carbon atoms, linear or branched, in particular the vinyl, allyl, 1-propenyl, 2-propenyl and butenyl group.

Within the meaning of the present invention, “C₂-C₄ alkyne group” means any alkyne group with 2 to 4 carbon atoms, linear or branched, in particular the ethynyl, acetylenyl or propargyl group.

Within the meaning of the present invention, “non-hydrolysable group” means any group that cannot react with water to give an —OH group. The presence of this non-hydrolyzable group in the organo alkoxysilane of formula II makes it possible to introduce within the network Si—O-M, Si—O—Si or M-O-M oxide bonds of the sol-gel material (sol-gel underlayer), organic functions which are either non-reactive (such as alkyls), or reactive and polymerizable (methacryloxy, epoxy, etc.) which will lead to certain parts of the material being totally organic. The sol-gel material (sol-gel underlayer) obtained is therefore a so-called “organic/inorganic hybrid sol-gel.” These functions thus make it possible to modulate the mechanical and thermal properties of the final sol-gel material (sol-gel underlayer) (much less fragile and brittle than simple Si—O-M, Si—O—Si or M-O-M groups) and also control the thickness of the layer. Moreover, it is also the non-hydrolysable group that ensures the chemical bonds between the sol-gel underlayer and the composite resin, in particular OMC, and therefore ensures the adhesion to the substrate, in particular OMC.

Within the meaning of the present invention, “C₆-C₁₀ aryl group” means one or more aromatic rings with 6 to 10 carbon atoms, possibly being joined or fused. In particular, the aryl groups can be monocyclic or bicyclic groups, preferably phenyl or naphthyl.

Within the meaning of the present invention, the term “condense the organic-inorganic hybrid network” means to polymerize each metal alkoxide together, each organo alkoxysilane together and/or each metal alkoxide with each organo alkoxysilane, i.e., the formation of oxo bridges, for example Si—O-M or Si—O—Si or M-O-M.

In one advantageous embodiment, the Si/M molar ratio in the sol-gel composition obtained in step a) is comprised between 0.1 and 0.5, advantageously between 0.2 and 0.5, in particular 0.3<Si/M<0.5.

In another advantageous embodiment, the metal alkoxide of formula (I) is chosen among aluminium isopropoxide (III), titanium butoxide (IV) and zirconium(IV) propoxide.

In another advantageous embodiment, the organo alkoxysilane of formula (II) is chosen among 3-aminopropyltrialcoxysilane (R²O)₃Si—(CH₂)₃—NH₂, 3-(2-aminoethyl)aminopropyltrialcoxysilane (R²O)₃Si—(CH₂)₃—NH—(CH₂)₂—NH₂, 3-(trialcoxysilyl)propyldiethylenetriamine (R²O)₃Si—(CH₂)₃—NH—(CH₂)₂—NH—(CH₂)₂—NH₂, 3-chloropropyltrialcoxysilane (R²O)₃Si—(CH₂)₃Cl, 3-mercaptopropyltrialcoxysilane (R²O)₃Si—(CH₂)₃SH, (3-glycidoxypropyl)trialcoxysilane, (trialcoxysilyl)propyl methacrylate, aminopropryltrialcoxysilane; N-(3-trialcoxysilylpropyl)-4,5-dihydroimidazole organosilyl azoles and mixtures thereof, R² having the same meaning as above. In particular, it is chosen among (3-glycidoxypropyl)trimethoxysilane, (trimethoxysilyl)propyl methacrylate, aminopropryltriethoxysilane and mixtures thereof.

The sol-gel composition according to the invention may or may not comprise oxide or metal particles. In another advantageous embodiment, the content of oxide or metal particles of the sol-gel composition obtained in step a) is 0-50% by mass relative to the total mass of the composition, in particular 3-40% by mass relative to the total mass of the composition, advantageously 5-30% by mass relative to the total mass of the composition, more advantageously 5-15% by mass relative to the total mass of the composition. Thus, advantageously, the sol-gel composition comprises oxide or metal particles.

The particles can have a size, in particular a diameter, ranging from 2 nm to 80 μm, in particular from 2 to 100 nm, advantageously they are nanoparticles, still more advantageously having a size, in particular a diameter, ranging from 10 to 60 nm, more preferentially from 20 to 50 nm. The diameter of these particles can be measured by transmission electron microscopy (TEM), X-ray diffraction and small angle X-ray scattering or light scattering.

Advantageously, the metal M of the metal alkoxide and/or the particles are of the same nature as those contained in the deposition of the subsequent coating layer, in particular the spray deposition, of step c) of the method according to the invention.

The substrate according to the invention is a composite. It can advantageously be an organic matrix composite (OMC), a ceramic matrix composite (CMC) or a metal matrix composite (MMC). In particular, the substrate is an organic matrix composite. Indeed, the adhesion of the sol-gel layer is reinforced on this type of substrate due to the presence of non-hydrolysable groups R³ in the organo alkoxysilane of formula II that led to the presence of certain parts of totally organic material in the sol-gel underlayer.

Organic matrix composite substrates are well known to the skilled person. They generally consist of a fibrous reinforcement densified by an organic matrix such as, for example, a thermosetting or thermoplastic resin, in particular chosen from an epoxy resin, polyimide, and polyurethane (thermosetting resin) or a polyetheretherketone (PEEK) resin, polyetherketoneketone (PEKK) resin, polyetherimide, polycarbonate, polyolefin (polyethylene or polypropylene), polyvinyl chloride (PVC) and polystyrene (thermoplastic resins), or a bismaleimide or cyanate-ester resin, more particularly an epoxy resin. They are predominantly organic.

The fabrication of these substrates is well known and begins by making a fibrous structure which can be in different forms, such as:—two-dimensional (2D) fabric,—three-dimensional (3D) fabric obtained by 3D or multilayer weaving,—braid,—knit,—felt,—unidirectional (UD) web of yarns or cables or multidirectional (nD) webs obtained by superimposing several UD webs in different directions and bonding the UD webs together, for example, by sewing, by chemical bonding agent or by needling. A fibrous structure can also be used formed of several superimposed layers of fabric, braid, knit, felt, web or other, said layers being bonded together, for example, by sewing, by implantation of yarns or rigid elements or by needling. The fibres making up the fibrous structure are especially refractory fibres, i.e., in general carbon, polymer or glass fibres, in particular carbon.

After optional shaping and consolidation, the fibrous structure is then densified. The densification of the fibrous structure consists of filling the porosity of the structure, in all or part of the volume thereof, by the material making up the matrix. The composite material matrix is obtained in a way known in itself, for example by following the liquid method. The liquid method consists of impregnating the fibrous structure with a liquid resin containing a matrix material precursor. The precursor is usually present in the form of a polymer optionally diluted in a solvent. The fibrous structure is placed in a mould that can be closed tightly with a recess having the shape of the final moulded part. Next, the mould is closed and the resin is injected into the entire recess to impregnate the fibrous texture. The transformation of the precursor into matrix, i.e., its polymerization, is performed by heat treatment, generally by heating the mould, after eliminating any solvent and cross-linking the polymer, the preform being still held in the mould. The matrix is an organic matrix such as a thermoplastic or thermosetting resin. The organic matrix can be especially obtained from epoxy resins, such as the high-performance epoxy resin sold under reference PR 520 by the company CYTEC.

According to one aspect of the invention, the fibrous preform can be densified by the well-known method of resin transfer moulding (RTM). In accordance with the RTM method, the fibrous preform is placed in a mould having the outer shape of the part to be created. A thermosetting resin is injected into the internal space of the mould which comprises the fibrous preform. A pressure gradient is generally established in this internal space between the place where the resin is injected and the discharge orifices thereof in order to control and optimize the impregnation of the preform by the resin.

The fibrous preform can also be densified in a known manner, by chemical vapor infiltration (CVI). The fibrous preform corresponding to the fibrous reinforcement of the substrate to be created is placed in an oven into which a reaction gas phase is admitted. The pressure and the temperature prevailing in the oven and the composition of the gas phase are chosen so as to allow the diffusion of the gas phase within the porosity of the preform to form the matrix therein by deposition, in the core of the material in contact with the fibres, of a solid material resulting from a decomposition of a constituent of the gas phase or from a reaction among several constituents, unlike the pressure and temperature conditions specific to the chemical vapor deposition (CVD) methods which lead to exclusively to a deposit on the surface of the material.

Ceramic matrix composite substrates are well known to the skilled person. They generally consist of a fibrous reinforcement often based on carbon fibres or silicon carbide fibres, sometimes aluminium oxide or alumina fibres (Al₂O₃), or mixed crystals of alumina and silicon oxide (SiO₂) called mullite (3Al₂O₃, 2SiO₂), densified by a ceramic matrix such as, for example, a matrix based on alumina, mullite, carbon or silicon carbide.

The fibrous structure can be made and the densification can be performed as indicated previously for organic matrix composites.

Metal matrix composite substrates are also well known to the skilled person. They generally consist of a fibrous reinforcement often based on ceramic fibres, for example silicon carbide, or metal fibres such as stainless steel wires, densified by a light metal matrix such as, for example, a matrix based on aluminium, magnesium, zinc or titanium.

The fibrous structure can be made and the densification can be performed as indicated previously for organic matrix composites.

In one advantageous embodiment of the invention, the composite substrate is a part intended for aeronautics, in particular an engine or nacelle part, more particularly a reactor or turbomachine part, advantageously a fan blade, a fan casing or an outlet guide vane (OGV).

The sol-gel underlayer of step b) is deposited by methods well known to the skilled person such as dip coating, spray coating, spin coating, spatula, film puller or brush, in particular by dip or spray coating.

In one advantageous embodiment of the invention, the thickness of the sol-gel underlayer obtained in step b) is at least 5 μm, in particular comprised between 5 μm and 200 μm (boundaries included), more particularly comprised between 10 μm and 200 μm. This thickness depends on the nature of the deposit of the subsequent layer of step c) meeting a functional need (protection from erosion, frost, ice, lightning, fire etc.).

Step c) of depositing the subsequent layer of the method according to the invention can be implemented by a method well known to the skilled person. It can therefore be a step of dip coating or spray coating. Advantageously, it is a step of thermal spraying such as cold spray or suspension plasma spraying (SPS) or air plasma spraying (APS) or flame spraying (such as high-velocity oxy-fuel (HVOF)) spraying. It can also be a compression heat treatment. It can advantageously be a cold spray, in particular at low pressure. These methods are well known to the person skilled in the art.

Advantageously, the subsequent coating layer of step c) is a layer of metal (pure metal or metal alloy), ceramic, cermet or reinforced or unreinforced polymer or a mixture, advantageously it is a layer of metal (pure metal or metal alloy), in particular titanium, aluminium or copper or a mixture of metals, for example a mixture of tin and copper. The particles deposited, in particular sprayed, during step c) of the method according to the invention are thus advantageously particles of metal (pure metal or metal alloy), ceramic, cermet, reinforced or unreinforced polymer or a mixture, in particular metal, such as titanium, aluminum or copper or a mixture of metals, for example a mixture of tin and copper. The subsequent cermet layer according to the invention can be a highly-filled cermet layer (preferably above 12% by weight) and a metal element such as Co, Ni, Cu, Al or an alloy of these elements, e.g., WC12Co, WC17Co. The subsequent metal layer according to the invention can be Ni, Al or Ti, or an Ni, Co, Al or Ti based alloy. For example, it can be:
an Ni based alloy, of the NiAI, NiCrAI or NiCrAIY type and, especially, an Ni based alloy comprising 5 to 20% by weight of AI, e.g. Ni5AI, NiCr-6AI;
an aluminium alloy comprising at most 12% by weight of Si;
a metal alloy (called “resistant”) based on Ni or Co highly filled with additional metal elements, e.g. CoMoCrSi, CoNiCrAIY;
a weakly alloyed Ti alloy such as TA6V, Ti6242 or Ti β21s.

Such metals or alloys have good mechanical properties, especially an interesting ductility and therefore good shock absorption, which allows them to be used, for example, as a protective reinforcement of the substrate, in particular of OMC, more particularly when the substrate is the leading edge of a blade, for example a fan or stator blade. Aluminium, copper and zinc and Sn—Zn and Sn—Cu alloys and aluminium alloys are useful to create a lightning protection layer. TiO₂ and SiO₂ are useful for creating an ice protection layer (anti-icing). Ti and TiN are useful for creating an erosion protection layer.

The thickness of the subsequent layer of the coating depends on its nature and function (protection from erosion, ice, lightning, fire etc.). It can vary, for example, between 50 μm and 200 μm or even reach several mm, for example between 0.5 mm and 20 mm.

In one advantageous embodiment, the method according to the invention comprises a prior step alpha) of preparing the surface of the composite substrate before step b) of depositing the sol-gel underlayer, advantageously by degreasing followed by sandblasting or sanding. This step improves the adhesion of the underlayer of step b) on the substrate. Step b) is therefore implemented on the composite substrate thus prepared, i.e., obtained at the end of this step.

In another advantageous embodiment, the method according to the invention comprises an intermediate step b1) of heat treatment. This intermediate step b1), which is located between steps b) and c), is a step of heat treating the coated composite substrate obtained in step b), at a maximum temperature of 200° C., in particular a temperature of 110° C., advantageously for 2 h, in particular for 1 h, step c) being therefore implemented on the substrate obtained in step b1). This heat treatment step is therefore optional and makes it possible to accelerate the polymerization of the sol-gel underlayer if this is necessary.

In another advantageous embodiment, the method according to the invention comprises an additional finishing step e) after step c) or after optional step d). This is a mechanical or chemical surface finishing step that leads to the final surface state required to ensure the desired function. It can particularly be performed by methods well known to the skilled person such as, for example, sandblasting, shot blasting, laser texturing, pressing, stamping, abrasion (paper or abrasive stone), machining, chemical etching or water jet.

In a variant of embodiment, the method according to the invention comprises an intermediate step b2). This intermediate step b2) which is located between steps b) and c) or between optional step b1) and c), is a step of increasing the roughness of the coated composite substrate surface obtained in step b) or step b1), step c) therefore being implemented on the substrate obtained in step b2). This step b2) can particularly be implemented by a method well known to the skilled person such as, for example, sandblasting, laser texturing, pressing, stamping, abrasion (paper or abrasive stone), machining, chemical etching or water jet. It improves the adhesion of the subsequent layer of step c) on the sol-gel underlayer according to the invention. This variant of the method according to the invention therefore comprises steps a), alpha), b), b1), b2), c), d) and e) such as described above, steps alpha), b1), d) and e) being optional.

In another variant of embodiment, fusible particles, i.e., particles which can be eliminated by heating or chemical treatment to free the imprint of the particle, for example polystyrene particles, are added to the sol-gel composition of step a) and the method according to the invention comprises the intermediate step b3). This intermediate step b3), located between steps b) and c), is a heat treatment step (for example at 170° C. for polystyrene particles, in particular for 30 minutes) or chemical etching to free the porosity of the substrate obtained in step b), step c) therefore being implemented on the substrate obtained in step b3). This variant of the method according to the invention therefore comprises steps a), alpha), b), b3), c), d) and e) such as described above, steps alpha), d) and e) being optional.

In still another variant of embodiment, the sol-gel composition obtained in step a) has a controlled state of gelation, i.e., a final state of polymerization of the organic-inorganic network making it possible to have a deformability of the layer allowing the particles deposited, in particular sprayed, to be embedded (polymerization is therefore not complete), and the particles deposited, in particular sprayed, during step c) penetrate into the sol-gel underlayer thus creating a concentration gradient of particles embedded in the underlayer. Indeed, in this variant, the sol-gel underlayer will have a good ability to be deformed on impact of the particles deposited, in particular sprayed, during step c). For this, the chemical composition of the sol-gel composition of step a) as well as its drying parameters are specifically chosen to allow a penetration of the particles deposited, in particular sprayed. In particular, the chemical precursors (metal alkoxide of formula (I) and organo alkoxysilane of formula (II) of the sol-gel composition), their proportions and their hydrolysable functions can be specifically chosen, as well as the particle size of the composition.

This state of the underlayer will allow:
embedding the particles deposited, in particular sprayed, and obtaining a thermal coefficient of expansion gradient;
increasing the roughness of the surface state of the underlayer and therefore improving the adhesion of the layer deposited, in particular sprayed, more particularly by thermal spraying;
protecting the composition substrate from erosion by the particles deposited, in particular sprayed;
controlling the polymerization rate of the sol-gel underlayer by contribution of the calories input by the particles deposited, in particular sprayed, during the spraying step.

This particle embedding gradient will also make it possible to control the differences of thermal expansion coefficient between the substrate and the final coating when the part is used.

In still another variant of embodiment, the method according to the invention comprises an intermediate step b4). This intermediate step, located between steps b) and c) or between optional step b1) and step c), is a step of coating the composite substrate obtained in step b) or optional step b1) by an additional underlayer of sol-gel composition obtained by mixture in an aqueous medium:

1—of at least one metal alkoxide of formula (I) M(OR¹)ₓ wherein

R¹ represents a C₁-C₄ alkyl group,

M represents a metal chosen from the group consisting of transition metals, lanthanides, phosphorus, magnesium, tin, zinc, aluminum and antimony and

x is an integer representing the metal valence,

in particular such as defined above,

2—in the presence of at least one organo alkoxysilane of formula (II)

R³ₘSi(OR²)₄₋ₘ, wherein

R² represents a C₁-C₄ alkyl group,

m represents an integer chosen between 1, 2 and 3,

and each R³ represents, independently of one another, a non-hydrolysable group chosen from polydimethylsiloxane, a C₁-C₁₈ alkyl group, C₂-C₄ alkenyl group, C₂-C₄ alkynyl group, C₆-C₁₀ aryl group, methacryl, methacryl (C₁-C₁₀ alkyl) or methacryloxy(C₁-C₁₀ alkyl), epoxylakyl or epoxyalkoxyalkyl wherein the alkyl group is linear, branched or cyclic C₁-C₁₀ alkyl group and the alkoxy group is C₁-C₁₀ alkoxy group, C₂-C₁₀ haloalkyl, C₂-C₁₀ perhaloalkyl, C₂-C₁₀ mercaptoalkyl, C₂-C₁₀ aminoalkyl (C₂-C₁₀ aminoalkyl)amino(C₂-C₁₀ alkyl), di(C₂-C₁₀ alkylene)triamino(C₂-C₁₀ alkyl), imidazolyl-(C₂-C₁₀ alkyl) and C₂-C₁₀ imidoalkyl, in particular such as defined above

the organo alkoxysilane may advantageously have been mixed beforehand with acidified water with stirring for the time necessary to hydrolyse and condense the organic-inorganic hybrid network,

3—and in the presence of optional oxide or metal particles, in particular such as defined above

4—by mixing the composition in order to allow condensation of the organic-inorganic hybrid networks, this method being advantageously as described above;

and said sol-gel composition having a controlled state of gelation, step c) being therefore implemented on the substrate obtained in step b4) so that the particles deposited, in particular sprayed, during step c) penetrate into the additional sol-gel underlayer thus creating a concentration gradient of particles embedded in the additional underlayer. In this variant, optional step b1) can be implemented after step b) and/or after step b4). This variant of the method according to the invention therefore comprises steps a), alpha), b), b1), b4), b1) c), d) and e) such as described above, steps alpha), b), b1), d) and e) being optional. The first underlayer (step b) thus mainly ensures the chemical adhesion with the substrate and the protection from erosion of the substrate and the second underlayer (step b4) makes it possible to obtain a coefficient of thermal expansion gradient and the roughness necessary for the adhesion of the subsequent layer deposited, in particular by spraying (step c). The compositions of the sol-gel mixture of the first and second underlayer can be identical or different; advantageously they are different.

The present invention also concerns a coated composite substrate, in particular a coated organic matrix composite, which is obtainable by the method according to the present invention, in particular as described above. It therefore comprises a coating made up of at least one sol-gel underlayer, in particular such as described above, and a subsequent layer, in particular obtained by spraying, more particularly by thermal spraying, in particular as described above.

In one advantageous embodiment of the invention, the coated composite substrate is a part intended for aeronautics, in particular an engine or nacelle part, more particularly a reactor or turbomachine part, advantageously a fan blade, a fan casing or an outlet guide vane (OGV).

The thickness of the sol-gel underlayer is advantageously at least 5 μm, more advantageously comprised between 5 μm and 200 μm, more particularly comprised between 10 μm and 200 μm. This thickness depends on the nature of the deposit of the subsequent layer, in particular thermally sprayed, which meets a functional need (protection from erosion, ice, lightning, fire etc.).

Advantageously, the subsequent coating layer of the substrate is a layer of metal (pure metal or metal alloy), ceramic, cermet or reinforced or unreinforced polymer or a mixture thereof, advantageously it is a layer of metal (pure metal or metal alloy), in particular titanium, aluminium or copper or a mixture of metals, for example a mixture of tin and copper. The subsequent cermet layer according to the invention can be a highly-filled cermet layer (preferably above 12% by weight) and a metal element such as Co, Ni, Cu, Al or an alloy of these elements, e.g., WC12Co, WC17Co. The subsequent metal layer according to the invention can be Ni, Al or Ti, or an Ni, Co, Al or Ti based alloy. For example, it can be:
an Ni based alloy, of the NiAI, NiCrAI or NiCrAIY type and, especially, an Ni based alloy comprising 5 to 20% by weight of AI, e.g. Ni5AI, NiCr-6AI;
an aluminium alloy comprising at most 12% by weight of Si;
a metal alloy (called “resistant”) based on Ni or Co highly filled with additional metal elements, e.g. CoMoCrSi, CoNiCrAIY;
a weakly alloyed Ti alloy such as TA6V, Ti6242 or Ti β21s.

Such metals or alloys have good mechanical properties, especially an interesting ductility and therefore good shock absorption, which allows them to be used, for example, as a protective reinforcement of the substrate, in particular when the substrate is the leading edge of a blade, for example a fan or stator blade. Aluminium, copper and zinc and Sn—Zn and Sn—Cu alloys and aluminium alloys are useful to create a lightning protection layer. TiO₂ and SiO₂ are useful for creating an ice protection layer. Ti and TiN are useful for creating an erosion protection layer.

The thickness of the subsequent layer of the coating depends on its nature and function (protection from erosion, ice, lightning, fire etc.). It can vary, for example, between 50 μm and 200 μm or even reach several mm, for example between 0.5 mm and 20 mm.

The present invention also concerns the use of a sol-gel composition, obtained by mixing in an aqueous medium:

1—of at least one metal alkoxide of formula (I) M(OR¹)ₓ wherein

R¹ represents a C₁-C₄ alkyl group,

M represents a metal chosen from the group consisting of transition metals, lanthanides, phosphorus, magnesium, tin, zinc, aluminum and antimony and

x is an integer representing the metal valence,

in particular such as defined above,

2—in the presence of at least one organo alkoxysilane of formula (II)

R³ₘSi(OR²)₄₋ₘ, wherein

R² represents a C₁-C₄ alkyl group,

m represents an integer chosen between 1, 2 and 3,

and each R³ represents, independently of one another, a non-hydrolysable group chosen from polydimethylsiloxane, a C₁-C₁₈ alkyl group, C₂-C₄ alkenyl group, C₂-C₄ alkynyl group, C₆-C₁₀ aryl group, methacryl, methacryl (C₁-C₁₀ alkyl) or methacryloxy(C₁-C₁₀ alkyl), epoxylakyl or epoxyalkoxyalkyl wherein the alkyl group is linear, branched or cyclic C₁-C₁₀ alkyl group and the alkoxy group is C₁-C₁₀ alkoxy group, C₂-C₁₀ haloalkyl, C₂-C₁₀ perhaloalkyl, C₂-C₁₀ mercaptoalkyl, C₂-C₁₀ aminoalkyl (C₂-C₁₀ aminoalkyl)amino(C₂-C₁₀ alkyl), di(C₂-C₁₀ alkylene)triamino(C₂-C₁₀ alkyl), imidazolyl-(C₂-C₁₀ alkyl) and C₂-C₁₀ imidoalkyl,

in particular such as defined above

the organo alkoxysilane may advantageously have been mixed beforehand with acidified water with stirring for the time necessary to hydrolyse and condense the organic-inorganic hybrid network,

3—and in the presence of optional oxide or metal particles, in particular such as defined above

4—by mixing the composition in order to allow condensation of the organic-inorganic hybrid networks, this method being advantageously as described above,

as an underlayer for a composite substrate, in particular an organic matrix composite, in order to protect said substrate and/or to improve the adhesion on said substrate, during the deposition of a subsequent layer, in particular by spraying, more particularly by thermal spraying. In particular, the sol-gel composition, the composite substrate and/or the subsequent layer are as described above.

The use can thus be to improve the adhesion of the subsequent layer on the substrate during deposition and/or the adhesion during use between the substrate and the subsequent layer.

The invention will be better understood upon reading the description of the figures and examples which follow, given by way of non-limiting indication.

### BRIEF DESCRIPTION OF THE DRAWINGS

FIG. 1 is a representative diagram in vertical section of a composite substrate (1) coated with a sol-gel underlayer (2) and with a subsequent coating layer (3) obtained by the method of the invention.

FIG. 2 is a representative diagram in vertical section of a composite substrate (1) coated with a sol-gel underlayer having a controlled state of gelation containing a gradient of particles (4) and with a subsequent coating layer (3) obtained by a variant of the method of the invention.

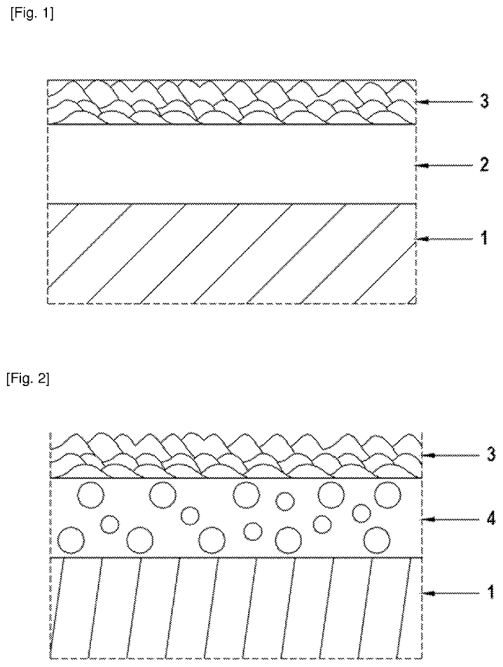

### EXAMPLE 1: SI—ZR SOL-GEL UNDERLAYER AND ZRO₂ PARTICLE BEFORE DEPOSITION BY THERMAL SPRAYING

The following compounds are added to a beaker in order and with magnetic stirring: a 70% by mass zirconium (IV) propoxide solution and glacial acetic acid, such that Zr/H⁺=2. After homogenization, distilled H₂O is added with stirring such that Zr/H₂O=15.

The solution is held with stirring approximately 1 hour until a homogeneous and clear solution is obtained.

To this solution is added (3-glycidoxypropyl)trimethoxysilane with stirring, such that Si/Zr=0.3. The stirring is maintained for approximately 1 hour until a homogeneous and clear solution is obtained. 5% by mass of ZrO₂ particles (mean diameter 50 nm) is added to this mixture with stirring and/or ultrasound.

Then an organic matrix composite (OMC) substrate is prepared, said OMC being made up of an epoxy matrix composite reinforced by carbon fibres, according to a methodology known to the skilled person, such as sanding or sand-blasting, followed by cleaning in order to remove any dust from the surface.

The formulation of the underlayer is then deposited on the OMC substrate by spray coating or dip coating so as t completely cover the surface, then within a time of a few minutes to one hour, the substrate thus coated is placed in the oven at 110° C. for 1 h.

The resulting substrate is then coated with a metal aluminium layer obtained by a low-pressure cold spray method.

### EXAMPLE 2: SI—TI SOL-GEL UNDERLAYER AND TIO₂ PARTICLE BEFORE DEPOSITION BY THERMAL SPRAYING

The following compounds are added to a beaker in order and with magnetic stirring: titanium (IV) butoxide and glacial acetic acid, such that Ti/H⁺=2 and then distilled H₂O is added with stirring such that Ti/H₂O=8.

The solution is held with stirring for approximately 30 minutes, before adding 3-(trimethoxysilyl)propyl methacrylate (γ-MPS) and aminopropryltriethoxysilane (APTES) still with stirring, such that Si/Ti=0.2 and γ-MPS/APTES=3. Stirring is maintained for approximately 1 hour. 5% by mass of TiO₂ particles (mean diameter 20 nm) is added to this mixture with stirring and/or ultrasound.

Then an organic matrix composite (OMC) substrate is prepared, said OMC being made up of an epoxy matrix composite reinforced by carbon fibres, according to a methodology known to the skilled person, such as sanding or sand-blasting, followed by cleaning in order to remove any dust from the surface.

The formulation of the underlayer is then deposited on the OMC substrate by spray coating or dip coating so as to completely cover the surface, then within a time of a few minutes to one hour, the substrate thus coated is placed in the oven at 110° C. for 1 h.

The resulting substrate is then coated by a metal titanium layer obtained by a low-pressure cold spray method.

### EXAMPLE 3: SI—AL UNDERLAYER BEFORE ALUMINIUM SPRAYING

The aluminum (III) isopropoxide precursor is mixed with distilled water (such that the H₂O/Al molar ratio=10). The mixture is held with stirring at 80° C. for 1 h.

The pH is adjusted to 3 by addition of concentrated nitric acid (68%) in order to form the oxide network. After 1 h of vigorous stirring at 80° C., a clear, blue and stable sol is obtained. The solution is left to return to ambient temperature and (3-glycidoxypropyl)trimethoxysilane is added thereto, such that Si/Al=0.3. The solution is held with stirring for 2 h.

Then an organic matrix composite (OMC) substrate is prepared, said OMC being made up of an epoxy matrix composite reinforced by carbon fibres, according to a methodology known to the skilled person, such as sanding or sand-blasting, followed by cleaning in order to remove any dust from the surface.

The formulation of the underlayer is then deposited on the OMC substrate by spray coating or dip coating so as t completely cover the surface, then within a time of a few minutes to one hour, the substrate thus coated is placed in the oven at 110° C. for 1 h.

The resulting substrate is then coated with a metal aluminium layer obtained by a low-pressure cold spray method.

### EXAMPLE 4: SI—TI SOL-GEL UNDERLAYER AND FUSIBLE POLYSTYRENE PARTICLES BEFORE DEPOSITION BY THERMAL SPRAYING

The following compounds are added to a beaker in order and with magnetic stirring: titanium (IV) butoxide and glacial acetic acid, such that Ti/H⁺=2 and then distilled H₂O is added with stirring such that Ti/H₂O=8.

The solution is held with stirring for approximately 30 minutes, before adding (3-glycidoxypropyl)trimethoxysilane (GPTMS) and aminopropryltriethoxysilane (APTES) still with stirring, such that Si/Ti=0.2 and GPTMS/APTES=5. Stirring is maintained for approximately 2 hours. 5% by mass of polystyrene particles (mean diameter 5 nm) is added to the mixture with stirring and/or ultrasound.

Then an organic matrix composite (OMC) substrate is prepared, said OMC being made up of an epoxy matrix composite reinforced by carbon fibres, according to a methodology known to the skilled person, such as sanding or sand-blasting, followed by cleaning in order to remove any dust from the surface.

The formulation of the underlayer is then deposited on the OMC substrate by spray coating or dip coating so as t completely cover the surface, then within a time of a few minutes to one hour, the substrate thus coated is placed in the oven at 110° C. for 1 h, then at 170° C. for 30 min in order to free the porosity of the polystyrene particles on the surface.

The resulting substrate is then coated by a metal titanium layer obtained by a low-pressure cold spray method.

### EXAMPLE 5: DOUBLE SI—TI SOL-GEL UNDERLAYER AND TIO₂ PARTICLE THEN SI—AL UNDERLAYER BEFORE DEPOSITION BY THERMAL SPRAYING OF AN ALUMINIUM LAYER

1^{st} Underlayer:

The following compounds are added to a beaker in order and with magnetic stirring: titanium (IV) butoxide and glacial acetic acid, such that Ti/H⁺=2 and then distilled H₂O is added with stirring such that Ti/H₂O=8. The solution is held with stirring for approximately 30 minutes, before adding 3-(trimethoxysilyl)propyl methacrylate (γ-MPS) and aminopropryltriethoxysilane (APTES) still with stirring, such that Si/Ti=0.2 and γ-MPS/APTES=3. Stirring is maintained for approximately 1 hour. 5% by mass of TiO₂ particles (mean diameter 20 nm) is added to this mixture with stirring and/or ultrasound.

Then an organic matrix composite (OMC) substrate is prepared, said OMC being made up of an epoxy matrix composite reinforced by carbon fibres, according to a methodology known to the skilled person, such as sanding or sand-blasting, followed by cleaning in order to remove any dust from the surface.

The formulation of the underlayer is then deposited on the OMC substrate by spray coating or dip coating so as to completely cover the surface, then within a time of a few minutes to one hour, the substrate thus coated is placed in the oven at 80° C. for 45 min.

2^{Nd} Underlayer:

Further, the aluminum (III) isopropoxide mixture is prepared with distilled water (such that the H₂O/AI molar ratio=10). The mixture is held with stirring at 80° C. for 1 h.

The pH is adjusted to 3 by addition of concentrated nitric acid (68%) in order to form the oxide network. After 1 h of vigorous stirring at 80° C., a clear, blue and stable solution is obtained. The solution is left to return to ambient temperature and (3-glycidoxypropyl)trimethoxysilane is added thereto, such that Si/Al=0.3. The solution is held with stirring for 2 h.

The formulation of this underlayer is then deposited on the OMC substrate covered with the preceding underlayer, by spray coating so as to completely cover the surface, then the substrate thus coated is placed in the oven at 110° C. for 1 h.

The resulting substrate is then coated with a metal aluminium layer obtained by a low-pressure cold spray method.

1. A method for coating a composite substrate, comprising the following steps:
a—preparing a sol-gel composition by mixing in an aqueous medium:
1—of at least one metal alkoxide of formula (I) M(OR¹)ₓ wherein
R¹ represents a C₁-C₄ alkyl group,
M represents a metal chosen from the group consisting of transition metals, lanthanides, phosphorus, magnesium, tin, zinc, aluminum and antimony and
x is an integer representing the metal valence,
2—in the presence of at least one organo alkoxysilane of formula (II) R³ₘSi(OR²)₄₋ₘ, wherein
R² represents a C₁-C₄ alkyl group,
m represents an integer chosen between 1, 2 and 3,
and each R³ represents, independently of one another, a non-hydrolysable group chosen from polydimethylsiloxane, a C₁-C₁₈ alkyl group, C₂-C₄ alkenyl group, C₂-C₄ alkynyl group, C₆-C₁₀ aryl group, methacryl, methacryl (C₁-C₁₀ alkyl) or methacryloxy(C₁-C₁₀ alkyl), epoxylakyl or epoxyalkoxyalkyl wherein the alkyl group is linear, branched or cyclic C₁-C₁₀ alkyl and the alkoxy group is a C₁-C₁₀ alkoxy group, C₂-C₁₀ haloalkyl, C₂-C₁₀ perhaloalkyl, C₂-C₁₀ mercaptoalkyl, C₂-C₁₀ aminoalkyl (C₂-C₁₀ aminoalkyl)amino(C₂-C₁₀ alkyl), di(C₂-C₁₀ alkylene)triamino(C₂-C₁₀ alkyl), imidazolyl-(C₂-C₁₀ alkyl) and C₂-C₁₀ imidoalkyl,
3—and in the presence of optional oxide or metal particles,
4—by mixing the composition in order to allow condensation of the organic-inorganic hybrid networks;
b—depositing at least one underlayer of the sol-gel composition obtained in step a) on a composite substrate, and
c—depositing at least one subsequent coating layer on the composite substrate coated with the underlayer obtained in step b).

2. The method according to claim 1, wherein the metal M is chosen in the group consisting of Cu, Mn, Sn, Fe, Mg, Zn, Al, P, Sb, Zr, Ti, Hf, Ce, Nb, V and Ta.

3. The method according to claim 1, wherein the Si/M molar ratio in the sol-gel composition obtained in step a) is comprised between 0.1 and 0.5.

4. The method according to claim 1, wherein a content of oxide or metal particles of the sol-gel composition obtained in step a) is 0-50% by mass relative to the total mass of the composition.

5. The method according to claim 1, wherein thickness of the sublayer obtained in step b) is comprised between 5 μm and 200 μm.

6. The method according to claim 1, wherein the subsequent coating layer of step c) is a layer of metal, ceramic, cermet or reinforced or unreinforced polymer or a mixture.

7. The method according to claim 1, wherein step c) is a thermal spraying step.

8. The method according to claim 1, wherein the substrate is an organic matrix composite.

9. The method according to claim 1, further comprising a prior step alpha) of preparing the surface of the composite substrate before step b) of depositing the sol-gel underlayer.

10. The method according to claim 1, further comprising an intermediate step b1), between steps b) and c), of heat treating the coated composite substrate obtained in step b), at a maximum temperature of 200° C., step c) being implemented on the substrate obtained in step b1).

11. The method according to claim 1, further comprising an intermediate step b2), between steps b) and c) or between optional step b1) and c), of increasing the roughness of the coated composite substrate surface obtained in step b) or step b1), step c) being implemented on the substrate obtained in step b2).

12. The method according to claim 1, wherein fusible particles are added to the sol-gel composition of step a) and wherein the method further comprises, between steps b) and c), the intermediate step b3) of thermal treatment or chemical etching to free the porosity of the substrate obtained in step b), step c) being implemented on the substrate obtained in step b3).

13. The method according to claim 1, wherein the sol-gel composition obtained in step a) has a controlled state of gelation and wherein the particles deposited during step c) penetrate into the sol-gel underlayer thus creating a concentration gradient of particles embedded in the underlayer.

14. The method according to claim 1, further comprising an intermediate step b4), between steps b) and c) or between optional step b1) and step c), of coating the composite substrate obtained in step b) or optional step b1) by an additional underlayer of sol-gel composition obtained by mixture in an aqueous medium:
1—of at least one metal alkoxide of formula (I) M(OR)ₓ,
2—in the presence of at least one organo alkoxysilane of formula (II) R³ₘSi(OR²)₄₋ₘ,
3—and in the presence of optional oxide or metal particles,
4—by mixing the composition in order to allow condensation of the organic-inorganic hybrid networks,
the sol-gel composition having a controlled state of gelation and in that step c) is implemented on the substrate obtained in step b4) so that the particles deposited during step c) penetrate into the additional sol-gel underlayer thus creating a concentration gradient of particles embedded in the additional underlayer.

15. The method according to claim 1, wherein the composite substrate is an engine or nacelle part.

16. A coated composite substrate obtainable by the method according to claim 1, wherein a thickness of the sol-gel underlayer of the substrate is comprised between 5 μm and 200 μm.

17. (canceled)

18. The method according to claim 4, wherein the content of oxide or metal particles of the sol-gel composition obtained in step a) is 5-15% by mass relative to the total mass of the composition.

19. The method according to claim 6, wherein the subsequent coating layer of step c) is a layer of metal.

20. The method according to claim 1, wherein the metal M is chosen in the group consisting of Zn, Ti and Al.

21. The method according to claim 15, wherein the composite substrate is a fan blade, a fan casing or an outlet guide vane.
